(19) United States
(12) Patent Application Publication
(10) Pub. No.: US 2009/0141214 A1
(43) Pub. Date: Jun. 4, 2009

(54) LIQUID CRYSTAL DEVICE, METHOD FOR PRODUCING THE SAME, AND ELECTRONIC APPARATUS

(75) Inventors: Katsumi Suzuki, Suwa (JP); Toshihiro Otake, Okaya (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/271,990

(22) Filed: Nov. 17, 2008

(30) Foreign Application Priority Data
Nov. 29, 2007 (JP) 2007-308411

(51) Int. Cl. G02F 1/13363

(52) U.S. Cl. 349/75; 349/187

(57) ABSTRACT

A liquid crystal device includes a pair of substrates; a partition wall member that partitions a region sandwiched between the pair of substrates to provide reflective display regions and transmissive display regions; a plurality of pixels each including a plurality of pixel regions, each of the pixel regions having each of the reflective display regions and each of the transmissive display regions; and a first liquid crystal layer made of a first liquid crystal and a second crystal layer made of a second liquid crystal, the first and the second liquid crystal layers, respectively, being enclosed in the reflective display region and the transmissive display region, respectively, partitioned by the partition wall member so as to sandwich the first and the second liquid crystal layers between the pair of substrates, wherein a phase difference value of reflected light in the first liquid crystal layer is approximately equal to a phase difference value of transmitted light in the second liquid crystal layer.

### BACKGROUND

1. Technical Field

The present invention relates to a liquid crystal device including a reflective display region and a transmissive display region, a method for producing the liquid crystal device, and an electronic apparatus.

2. Related Art

Among liquid crystal devices, there is known a liquid crystal display including an array substrate having a plurality of scan lines and a plurality of signal lines mutually intersecting and an opposing substrate located on an opposite side of a liquid crystal layer from the array substrate. At intersections between the scan lines and the signal lines are provided respective pixels of red, blue, and green, each having a reflecting section having an external-light reflecting unit and a phase difference film. In the liquid crystal display, when phase difference values of the phase difference films in the respective red, blue, and green pixels are represented by rR, rG, and rB, respectively, at least one of expressions: rR>rG; rG>rB and rR>rB holds true, as well as expressions: 120 nm<rR<180 nm; 110 nm<rG<170 nm; and 80 nm<rB<140 nm hold true (See JP-A-2006-292847).

Regarding the liquid crystal display above, optical characteristics of the red, blue, and green pixels are considered to define the phase difference values of the pixels, thereby preventing contrast ratio reduction and reducing coloring upon reflective display.

In addition, there is known another liquid crystal display including a liquid crystal layer and a first and a second substrate sandwiching the liquid crystal layer therebetween. A single pixel has a reflective display section and a transmissive display section therein. In the reflective display section, the liquid crystal layer has a retardation of ¼ wavelength and a phase difference plate has a retardation of ½ wavelength (See JP-A-2005-338256).

The liquid crystal display described as the other example is a so-called semi-transmissive in-plane switching (IPS) mode LCD. With the optical design as above, the display is proposed to realize a wide viewing angle equivalent to that of a transmissive IPS mode LCD.

In the above liquid crystal displays, the phase difference film or the phase difference plate is disposed at a side facing the liquid crystal layer. JP-A-2006-292847 discloses an example of a method for forming such an internal phase difference film. In the method, a mixture of a liquid crystalline high polymer and a photosensitive resin is applied on a substrate to perform pattering by photo-etching.

However, in the method for forming the phase difference film as above, the phase difference film needs to be patterned in accordance with the red, blue, and green pixels, which complicates a production process of the display.

Furthermore, patterning by photo-etching leads to wasted use of most of a material for the phase difference film.

### SUMMARY

The present invention has been accomplished to solve at least a part of the above problems and is realized in various aspects as below. An advantage of the present invention is to provide a liquid crystal device and a method for producing the liquid crystal device, which can exhibit high contrast in both of reflective and transmissive modes, thereby providing excellent image quality. Another advantage of the invention is to provide an electronic apparatus incorporating the liquid crystal device.

A liquid crystal device according to a first aspect of the invention includes a pair of substrates; a partition wall member that partitions a region sandwiched between the pair of substrates to provide reflective display regions and transmissive display regions; a plurality of pixels each including a plurality of pixel regions, each of the pixel regions having each of the reflective display regions and each of the transmissive display regions; and a first liquid crystal layer made of a first liquid crystal and a second crystal layer made of a second liquid crystal, the first and the second liquid crystal layers, respectively, being enclosed in the reflective display region and the transmissive display region, respectively, partitioned by the partition wall member so as to sandwich the first and the second liquid crystal layers between the pair of substrates, wherein a phase difference value of reflected light in the first liquid crystal layer is approximately equal to a phase difference value of transmitted light in the second liquid crystal layer.

In the above structure, the first and the second liquid crystals, respectively, are separately enclosed in the reflective display region and the transmissive display region, respectively, partitioned by the partition wall member, as well as the phase difference value of reflected light in the reflective display region is approximately equal to that of transmitted light in the transmissive display region. Thereby, there can be provided a semi-transmissive reflective liquid crystal device including the pixels, each pixel region having the reflective display region and the transmissive display region that are optically compensated. In addition, as compared to including a phase difference film in at least the reflective display region to provide such an optical compensation, the semi-transmissive reflective liquid crystal device of the first aspect can be structurally further simplified.

Preferably, in the liquid crystal device of the first aspect, a layer thickness of the first liquid crystal layer is approximately equal to a layer thickness of the second liquid crystal layer, and a birefringence index of the first liquid crystal is half a birefringence index of the second liquid crystal.

In general, the phase difference value of a liquid crystal layer is obtained by multiplying a birefringence index of a liquid crystal forming the liquid crystal layer by a layer thickness of the liquid crystal layer. In the above preferable structure, the partition wall member between the pair of substrates is formed to have a uniform height, whereby the phase difference value of reflected light in the reflective display region can be made approximately equal to that of transmitted light in the transmissive display region. Thus, there can be realized a so-called single gap structure that is structurally simple.

Preferably, in the liquid crystal device of the first aspect, one substrate of the pair of substrates includes a liquid-crystal-layer-thickness adjusting layer in the reflective display region to adjust a thickness of the first liquid crystal layer such that the thickness of the first liquid crystal layer is smaller than a thickness of the second liquid crystal layer, and a birefringence index of the first liquid crystal is smaller than a birefringence index of the second liquid crystal.

In the above structure, the reflective display region has the liquid-crystal-layer-thickness adjusting layer. Thus, there is employed a so-called multigap structure. As described above, the phase difference value of a liquid crystal layer is obtained by multiplying a birefringence index of the liquid crystal forming the liquid crystal layer by a layer thickness of the liquid crystal layer. Accordingly, adjusting a thickness of the liquid-crystal-layer-thickness adjusting layer can widen a range of material options for the first and the second liquid crystals having the mutually different birefringence indexes.

Preferably, in the liquid crystal device of the first aspect, one substrate of the pair of substrates includes a color filter having a plurality of different color filter elements, each of the color filter elements being provided in each of the pixel regions partitioned by the partition wall member.

In the above structure, there can be obtained a semi-transmissive reflective liquid crystal device that is structurally simple and enables color display.

Preferably, in the liquid crystal device of the first aspect, one substrate of the pair of substrates includes a color filter having a plurality of different color filter elements, each of the color filter elements being provided in each of the pixel regions partitioned by the partition wall member, and a liquid-crystal-layer-thickness adjusting layer in the reflective display region to adjust a thickness of the first liquid crystal layer, a thickness of the liquid-crystal-layer-thickness adjusting layer corresponding to at least one of the color filter elements is different from a thickness of the liquid-crystal-layer thickness adjusting layer corresponding to at least another one of the color filter elements.

In the above structure, the thickness of the liquid-crystal-layer-thickness adjusting layer is adjusted corresponding to individual colors of the color filter elements, whereby there can be provided a liquid crystal device that is optically compensated in accordance with absorption wavelengths of the filter elements.

Preferably, in the liquid crystal device of the first aspect, the partition wall member is made of a light-shielding material.

In the above structure, the reflective display region and the transmissive display region are separated and partitioned from each other by the partition wall member having light-shielding properties, so that light leakage occurring in each of the two regions has little influence on each other's region. Accordingly, there can be provided a semi-transmissive reflective liquid crystal device that is structurally simple and capable of displaying sharper images.

A method for producing a liquid crystal device according to a second aspect of the invention includes forming a partition wall member on one substrate of a pair of substrates to partition a plurality of pixels each including a plurality of pixel regions, each of the pixel regions having a reflective display region and a transmissive display region, as well as to partition the reflective display region from the transmissive display region; filling a first liquid crystal and a second liquid crystal, respectively, in the reflective display region and the transmissive display region, respectively, partitioned from each other by the partition wall member on the one substrate; and bonding the pair of substrates together so as to sandwich a first liquid crystal layer made of the first liquid crystal and a second liquid crystal layer made of the second liquid crystal between the pair of substrates, wherein the first and the second liquid crystals are selected such that a phase difference value of reflected light in the first liquid crystal layer is approximately equal to a phase difference value of transmitted light in the second liquid crystal layer.

In the above production method, in the constructing, the first liquid crystal and the second liquid crystal, respectively, are separately filled in the reflective display region and the transmissive display region, respectively, partitioned by the partition wall member, where the phase difference value of reflected light in the first liquid crystal layer is made approximately equal to that of transmitted light in the second liquid crystal layer. Thus, the method can produce a semi-transmissive reflective liquid crystal device including the plurality of pixels, each including the reflective display region and the transmissive display region that are optically compensated. Additionally, as compared to disposing a phase difference film in at least the reflective display region to provide such an optical compensation, the production method of the second aspect can simplify a process for producing the semi-transmissive reflective liquid crystal device.

Preferably, in the method of the second aspect, the partition wall member is formed using a light-shielding material.

In this method, the reflective display region and the transmissive display region are separated and partitioned from each other by the partition wall member having light-shielding properties. Thus, light leakage occurring in each of the display regions hardly influences on each other's region. Therefore, the method can produce a semi-transmissive reflective liquid crystal device that is structurally simple and capable of displaying sharper images.

Preferably, in the method of the second aspect, in the constructing, the pair of substrates are bonded together such that a layer thickness of the first liquid crystal layer is approximately equal to a thickness of the second liquid crystal layer, and a birefringence index of the first liquid crystal is half a birefringence index of the second liquid crystal.

In this method, the partition wall member is formed to have a uniform height, so that the phase difference value of reflected light in the reflective display region can be made approximately equal to that of transmitted light in the transmissive display region. Thus, the method can produce a semi-transmissive reflective liquid crystal device by employing the so-called single gap structure that is structurally simple.

Preferably, the method according to the second aspect further includes forming a liquid-crystal-layer-thickness adjusting layer in the reflective display region partitioned by the partition wall member on the one substrate to adjust a thickness of the first liquid crystal layer; and in the constructing, the first liquid crystal filled in the reflective display region has a birefringence index smaller than a birefringence index of the second liquid crystal.

In this method, the liquid-crystal-layer-thickness adjusting layer is provided in the reflective display region, thereby forming the so-called multigap structure. Thus, adjusting the thickness of the liquid-crystal-layer-thickness adjusting layer in the reflective display region can widen the range of material options for the first and the second liquid crystals having the mutually different birefringence indexes. This can facilitate selection of materials for the first and the second liquid crystals.

Preferably, the method according to the second aspect further includes forming a color filter having a plurality of different color filter elements such that each of the different color filter elements is formed in each of the pixel regions partitioned by the partition wall member on the one substrate.

In this method, there can be provided a semi-transmissive reflective liquid crystal device that is structurally simple and enables color display.

Preferably, the method according to the second aspect further includes forming a color filter having a plurality of different color filter elements such that each of the color filter elements is formed in each of the pixel regions partitioned by the partition wall member on the one substrate, and forming a liquid-crystal-layer-thickness adjusting layer in the reflective display region partitioned by the partition wall member on the one substrate to adjust a thickness of the first liquid crystal layer, wherein the liquid-crystal-layer-thickness adjusting layer is formed such that a thickness of the liquid-crystal-layer-thickness adjusting layer corresponding to at least one of the different color filter elements is different from a thickness of the liquid-crystal-layer-thickness adjusting layer corresponding to at least another one of the different color filter elements.

In this method, the thickness of the liquid-crystal-layer-thickness adjusting layer is adjusted corresponding to the colors of the filter elements, thereby realizing optical compensation in accordance with absorption wavelengths of the filter elements.

Preferably, in the method according to the second aspect, forming the liquid-crystal-layer-thickness adjusting layer includes applying a droplet of a liquid containing a material of the liquid-crystal-layer-thickness adjusting layer in the reflective display region, and then forming a deposit film by drying the applied liquid to obtain the liquid-crystal-layer-thickness adjusting layer.

The above method employs a liquid droplet discharging method used to apply a liquid droplet. Thus, adjusting an applying amount of the liquid can facilitate control of the thickness of the liquid-crystal-layer-thickness adjusting layer in the reflective display region. Accordingly, as compared to methods such as spin coating for performing film deposition by collectively applying all of a liquid material on a substrate, the liquid-crystal-layer-thickness adjusting layer can be accurately formed without wasting the material used.

Preferably, in the above method, forming the color filter includes applying a droplet of each of at least three different color liquids in each of the pixel regions, the droplet of the each of the liquids containing a material of each of the different color filter elements, and then forming deposit films by solidifying the applied droplets to obtain the color filter elements having at least three colors of red, green, and blue.

The above method employs the liquid droplet discharging method used to apply liquid droplets. Thus, adjusting applying amounts of the liquids can facilitate control of thicknesses of the filter elements in the each pixel region. In short, as compared to a case of forming a plurality of color filter elements by photolithography, the filter elements can be accurately formed without wasting the materials used.

Preferably, in the method of the second aspect, the constructing includes first discharging a droplet of the first liquid crystal in the reflective display region, and then discharging a droplet of the second liquid crystal in the transmissive display region.

In this method, droplets of the first and the second liquid crystals, respectively, are separately discharged in the reflective display region and the transmissive display region, respectively. In short, using the liquid droplet discharging method can facilitate separate discharging of the droplets of the respective liquid crystals. In addition, using an inkjet method as the liquid droplet discharging method enables accurate amounts of the liquid crystals to be applied in the respective desired regions.

An electronic apparatus according to a third aspect of the invention includes the liquid crystal device of the first aspect or a liquid crystal device produced by the method according to the second aspect.

In the above structure, the electronic apparatus of the third aspect incorporates the structurally simple semi-transmissive reflective liquid crystal device, thus achieving an excellent cost performance ratio.

### BRIEF DESCRIPTION OF THE DRAWINGS

The invention will be described with reference to the accompanying drawings, wherein like numbers reference like elements.

FIG. 1 is an equivalent circuit diagram showing an electrical configuration of a liquid crystal device according to a first embodiment of the invention.

FIG. 2 is a schematic plan view showing a structure of a pixel.

FIG. 3A is a sectional view showing a structure of the liquid crystal device taken along line A-A′ of FIG. 2.

FIG. 3B is a sectional view showing a structure of the liquid crystal device taken along line B-B′ of FIG. 2.

FIG. 4 is a schematic diagram showing optical design conditions of the liquid crystal device.

FIG. 5 is a flowchart showing a method for producing the liquid crystal display.

FIGS. 6A to 6E are schematic sectional views showing the method for producing the liquid crystal device.

FIGS. 7F to 7G are also schematic sectional views showing the method for producing the liquid crystal device.

FIGS. 8A and 8B are schematic sectional views showing a structure of a liquid crystal device according to a second embodiment of the invention.

FIG. 9 is a flowchart showing a method for producing the liquid crystal display according to the second embodiment.

FIGS. 10A to 10D are schematic sectional views showing the method for producing the liquid crystal device according to the second embodiment.

FIG. 11 is a schematic perspective view showing a mobile phone as an electronic apparatus according to an embodiment of the invention.

FIGS. 12A and 12B are schematic plan views showing different layouts of a partition wall member.

### DESCRIPTION OF EXEMPLARY EMBODIMENTS

Hereinafter, embodiments of the invention will be described below with reference to drawings.

### First Embodiment

Liquid Crystal Device

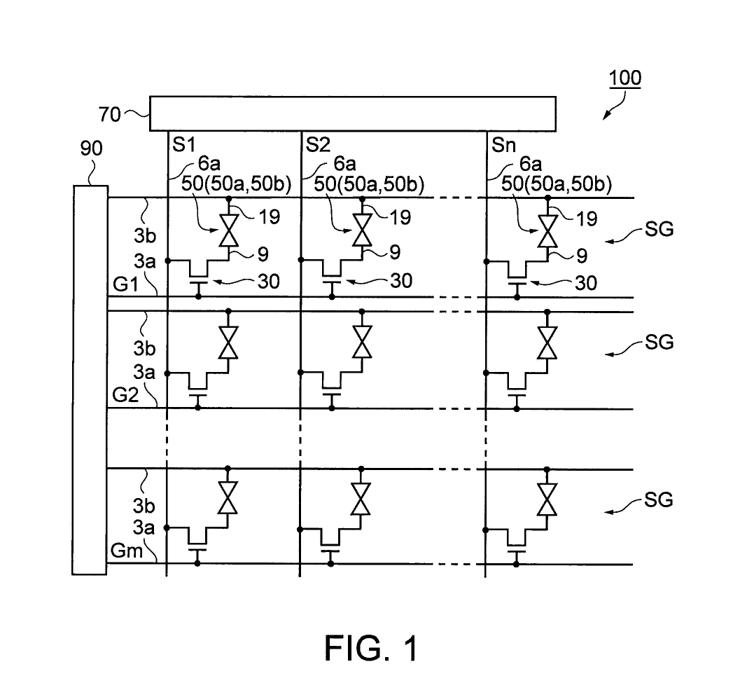

First will be described a liquid crystal device according to a first embodiment of the invention. FIG. 1 is an equivalent circuit diagram showing an electrical configuration of the liquid crystal device.

As shown in FIG. 1, a liquid crystal device 100 of the embodiment includes a plurality of sub pixels SG. Each of the sub pixels SG includes a pixel electrode 9, a common electrode 19, and a thin film transistor (TFT) 30 that switchingly controls the pixel electrode 9. Between the pixel electrode 9 and the common electrode 19 of the each sub pixel SG is interposed a liquid crystal layer 50. The liquid crystal layer 50 is composed of a first liquid crystal layer 50a and a second liquid crystal layer 50b, although details of the liquid crystal layer 50 will be described later. Each common electrode 19 is electrically connected to each of common lines 3b extended from a scan-line driving circuit 90 so as to be maintained at an electric potential common to the each sub pixel SG.

Each of a plurality of data lines 6a is extended from a data-line driving circuit 70 to be electrically connected to a source of the TFT 30. The data-line driving circuit 70 supplies image signals S1 to Sn to the each sub pixel SG via the each data line 6a. The image signals S1 to Sn may be supplied in this numerical order in a line-by-line sequence, or may be supplied to each group of mutually adjacent ones of the data lines 6a.

A gate of each TFT 30 is electrically connected to each scan line 3a extended from the scan-line driving circuit 90. The scan-line driving circuit 90 supplies respective pulses of the scan signals G1 to Gm to the each scan line 3a at a predetermined timing, whereby the signals G1 to Gm are applied to the gate of the each TFT 30 in this numerical order in a line-by-line sequence at a predetermined timing. The pixel electrode 9 is electrically connected to a drain of the TFT 30.

Each of the scan signals G1 to Gm is input to the each TFT 30 as a switching element to turn on the transistor. The TFT 30 is maintained in an on-state for a predetermined time to allow each of the image signals S1 to Sn supplied from the data lines 6a to be written in the each pixel electrode 9 at a predetermined timing. Each of the image signals S1 to Sn of a predetermined level is written into liquid crystal via the pixel electrode 9 to be retained for a predetermined time between the pixel electrode 9 and the common electrode 19 opposing the pixel electrode 9 via the liquid crystal.

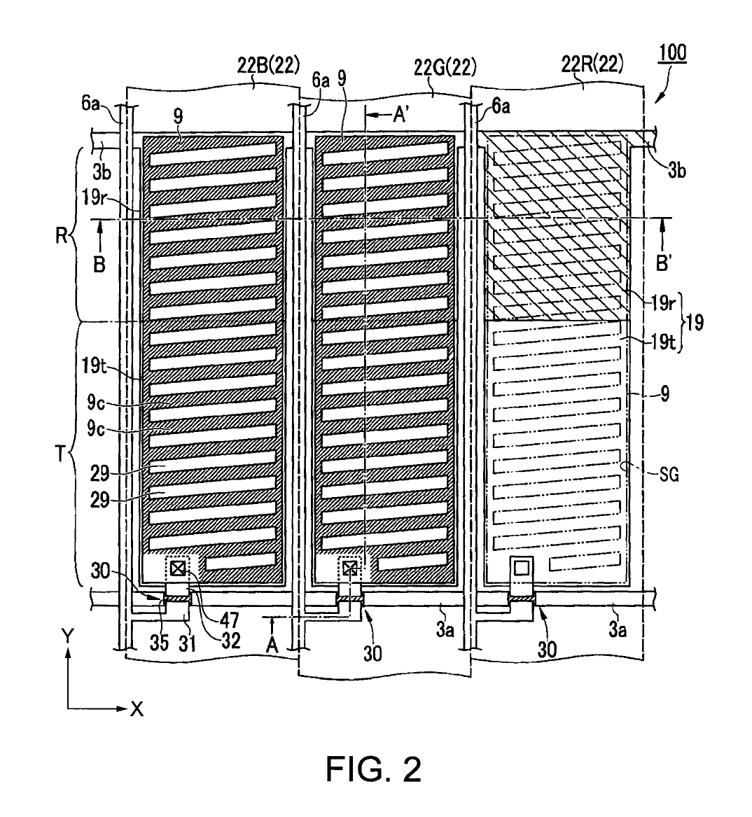

FIG. 2 is a schematic plan view showing a structure of a pixel. In the drawing, the liquid crystal device 100 includes a plurality of pixels each including a unit of three sub pixels SG corresponding to three different color filter elements 22R (red), 22G (green), and 22B (blue). Hereinafter, a region having a single sub pixel SG will be referred to as “sub-pixel region”. In the each sub pixel SG, the pixel electrode 9 is rectangular-shaped and has a plurality of slits (gaps) 29 that are formed in a roughly ladder-like shape. Additionally, at an outer periphery of the pixel electrode 9 are arranged the scan line 3a, the common line 3b, and the data line 6a so as to surround the pixel electrode 9.

The TFT 30 is formed near an intersection between the scan line 3a and the data line 6a to be electrically connected to the data line 6a and the pixel electrode 9. In addition, the common electrode 19 having a rectangular shape is provided in a position approximately overlapping with the pixel electrode 9 in a two-dimensional view.

The pixel electrode 9 is a conductive film made of a transparent conductive material such as indium tin oxide (ITO). The pixel electrode 9 of a single sub pixel SG has 17 slits 29 formed therein. The slits 29 are extended in a direction intersecting with both the scan line 3a and the data line 6a (in an oblique direction in FIG. 2) to be formed so as to be arranged at equal distances from each other in a Y-axis direction. The slits 29 have approximately an equal width and are parallel to each other. Consequently, the pixel electrode 9 has a plurality of (16 in FIG. 2) band-shaped electrodes 9c. Since the slits 29 with the equal width are positioned at mutually equal distances, the band-shaped electrodes 9c are also equal in width and positioned at equal distances from each other. In the present embodiment, the widths of the slit 29 and the band-shaped electrode 9c are both 4 μm.

The common electrode 19 includes a transparent common electrode 19t and a reflective common electrode 19r. The transparent common electrode 19t has an approximately rectangular shape in a two-dimensional view and is made of a transparent conductive material such as ITO. The reflective common electrode 19r is approximately rectangular in a two-dimensional view and made of a metal having light reflectivity, such as aluminum or silver. The common electrodes 19t and 19r are electrically connected to each other at side ends of the electrodes.

The reflective common electrode 19r is integrally formed with the common line 3b extended in parallel to the scan line 3a. Thus, the common electrode 19 including the transparent common electrode 19t and the reflective common electrode 19r is electrically connected to the common line 3b.

A region having the reflective common electrode 19r formed therein constitutes a reflective display region R of the sub pixel SG, whereas a region having the transparent common electrode 19t constitutes a transmissive display region T. That is, in the liquid crystal device 100, the reflective common electrode 19r serves as a reflecting layer, and the each sub pixel SG has the reflective common electrode 19r and the transparent common electrode 19t formed therein.

Alternatively, the common line 3b and the reflective common electrode 19r may be formed by separate conductive films to be electrically connected to each other. To do that, for example, the reflective common electrode 19r and the common line 3b may be formed on different wiring layers located via an interlayer insulating film and then the electrode 19r and the line 3b may be connected to each other by a contact hole formed in the interlayer insulating film. Additionally, the transparent common electrode 19t may be formed so as to cover the reflective common electrode 19r.

The TFT 30 includes a semiconductor layer 35 made of an island-shaped amorphous silicon film and partially formed in a position above the scan line 3a; a source electrode 31 branched from the data line 6a to be extended on a surface of the semiconductor layer 35; and a rectangular drain electrode 32 extended from the surface of the semiconductor layer 35 to a region where the pixel electrode 9 is formed.

The scan line 3a serves as a gate electrode of the TFT 30 at a position opposing the semiconductor layer 35. The drain electrode 32 is electrically connected to the pixel electrode 9 by a pixel contact hole 47 formed at a position where the drain electrode 32 and the pixel electrode 9 two-dimensionally overlap with each other.

In the each sub pixel SG shown in FIG. 2, a region where the pixel electrode 9 two-dimensionally overlaps with the common electrode 19 serves as a capacitance of the sub pixel SG. Accordingly, no additional retention capacitance is needed to retain an image signal in the sub pixel region, thus obtaining a high aperture ratio.

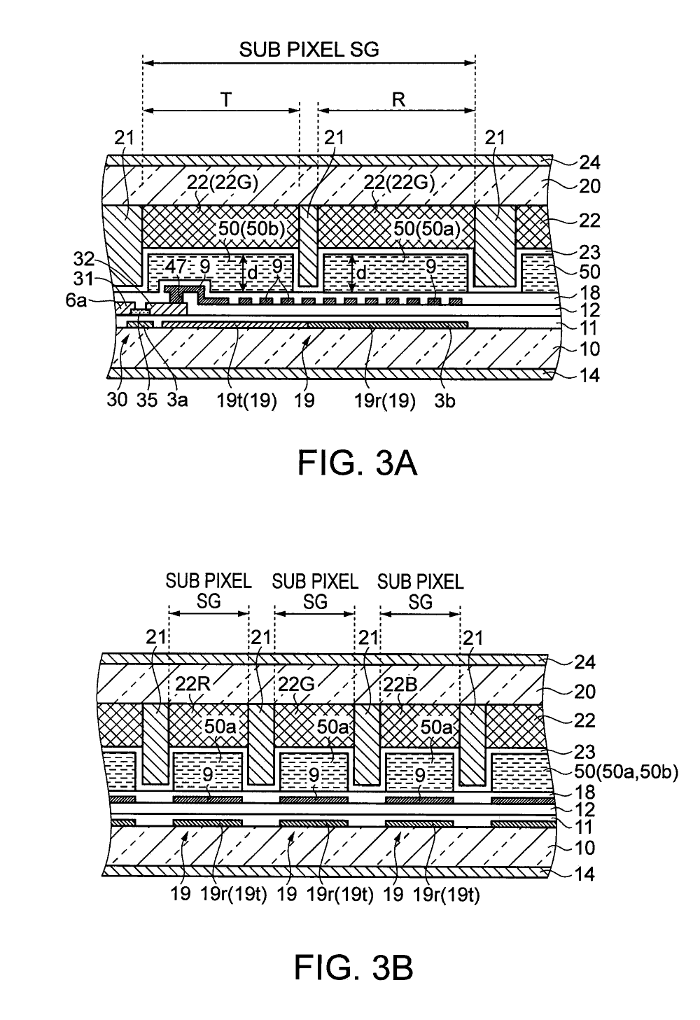

With reference to FIGS. 3A and 3B, the structure of the liquid crystal device 100 will be described in more detail. FIG. 3A schematically shows a sectional view of the structure of the liquid crystal device. Specifically, FIG. 3A is a sectional view taken along line A-A″ of FIG. 2, and FIG. 3B is a sectional view taken along line B-B′ of the same.

As shown in FIG. 3A, the liquid crystal device 100 includes a pair of substrates, namely an opposing substrate 20 and an element substrate 10. The element substrate 10 has a first and a second surface, in which the pixel electrodes 9 are formed at a side adjacent to the first surface thereof and the common electrodes 19 are provided on the first surface thereof. The liquid crystal layer 50 is sandwiched between the opposing substrate 20 and the element substrate 10. On a region (a display region) between the element substrate 10 and the opposing substrate 20, there are provided a color filter 22 and a partition wall member 21that partitions the color filter 22 (22G) for the each sub pixel SG (for each color), as well as that partitions the reflective display region R from the transmissive display region T.

The reflective display region R and the transmissive display region T partitioned from each other by the partition wall member 21, respectively, enclose a first liquid crystal layer 50a and a second liquid crystal layer 50b, respectively. Layer thicknesses (cell thicknesses) d of the first and the second liquid crystal layers 50a and 50b are approximately equal.

The liquid crystal device 100 structured as above performs reflective display and transmissive display. However, there is a problem in terms of an optical design. When a phase difference exists between external light reflected by the reflective common electrode 19r (reflected light) and transmitted light transmitting through the transmissive display region T, coloring occurs upon reflective black display, thereby making it difficult to obtain a high-contrast reflective display. This results from that the reflected light is emitted from a side of the opposing substrate 20 opposite from a location of the element substrate 10 via an optical path equal to or longer than twice an optical path of the transmitted light.

The phase difference, namely, a phase difference value (retardation) is obtained by multiplying a birefringence index Δn of liquid crystal by a layer thickness d.

Thus, the present embodiment uses first and second liquid crystals each having a positive dielectric anisotropy and having mutually different birefringence indexes Δn. Between the pair of substrates are placed the first liquid crystal layer 50a made of the first liquid crystal and the second liquid crystal layer 50b made of the second liquid crystal. The first liquid crystal layer 50a and the second liquid crystal layer 50b, respectively, are located in the reflective display region R and the transmissive display region T, respectively, which are partitioned by the partition wall member 21. The birefringence index of the first liquid crystal is set to half the birefringence index of the second liquid crystal. Thereby, while the thicknesses d of the first and the second liquid crystal layers 50a and 50b are approximately equal, the phase difference value of the first liquid crystal layer 50a in the reflective display region R is set to approximately half the phase difference value of the second liquid crystal layer 50b in the transmissive display region T. This eliminates a phase difference between light transmitting through the transmissive display region T (transmitted light) and light input to the reflective display region R, then reflected by the reflective common electrode 19r, and re-input to an upper polarizing plate 24 (reflected light).

In this case, when the respective birefringence indexes of the first and the second liquid crystals are Δn₁ and Δn₂, an equation: 2Δn₁=Δn₂ holds true. Additionally, the first liquid crystal is selected such that when λ represents a wavelength of light, an equation: Δn₁×d=λ/4 holds true. Meanwhile, the second liquid crystal is selected such that an equation: Δn₂×d=λ/2 holds true. The layer thickness d is not necessarily uniform but varies to some extent in production of the liquid crystal device 100. Thus, preferably, an occurrence of variation in the layer thickness is suppressed such that no malfunction occurs in substantial transmissive and reflective displays. In other words, when the variation in production is recognized, it may be allowable that the variation causes a phase difference between the transmitted light and the reflected light.

On the first surface of the element substrate 10 made of transparent glass or the like are provided the scan lines 3a, the common electrodes 19, and the common lines 3b. In addition, on the same surface of the substrate 10 is provided an insulating thin film 11 made of a silicon oxide film or the like so as to cover the scan lines 3a, the common electrodes 19, and the common lines 3b. On the insulating thin film 11 are formed the island-shaped semiconductor layer 35, the source electrode 31 (the data line 6a), and the drain electrode 32, where the respective electrodes 31 and 32 partially overlap with the semiconductor layer 35, thereby forming each TFT 30. Then, the semiconductor layer 35, the source electrode 31, and the drain electrode 32 are covered by an interlayer insulating film 12 made of a silicon oxide or resin film. On the interlayer insulating film 12 is formed the pixel electrode 9. The pixel electrode 9 is electrically connected to the drain electrode 32 by the pixel contact hole 47 reaching the drain electrode 32 after penetrating through the interlayer insulating film 12. A boundary between the transparent common electrode 19t and the reflective common electrode 19r of the common electrode 19 is located immediately under the partition wall 21 that partitions the transmissive display region T and the reflective display region R.

An alignment film 18 made of polyimide or the like is formed to cover the pixel electrodes 9. The alignment film 18 is subjected to an alignment treatment such as rubbing to align the liquid crystals in a predetermined direction. In the present embodiment, a direction of alignment control by the alignment film 18 is parallel to an extending direction of the data lines 6a and intersects with an extending direction of the slits 29 of each of the pixel electrode 9.

Like the element substrate 10, the opposing substrate 20 is made of transparent glass or the like and has a first and a second surface. On the first surface of the opposing substrate 20 are formed the color filter 22 (22G), the first and the second liquid crystal layers 50a, 50b, the partition wall member 21 substantially partitioning those constituent elements, and an alignment film 23, which are located sequentially in a direction orienting toward the liquid crystal layer 50. In addition, the upper polarizing plate 24 is attached onto the second surface of the opposing substrate 20 (a surface of the substrate 20 opposite from the location of the liquid crystal layer 50). Optical layouts of the upper polarizing plate 24 and a lower polarizing plate 14 attached onto the second surface of the element substrate 10 (a surface of the substrate 10 opposite from the location of the liquid crystal layer 50 are arranged in a crossed Nicol relation. The respective alignment films 18 and 23 are subjected to rubbing such that liquid crystal molecules of the first and the second liquid crystal layers 50a and 50b are aligned in a direction parallel to the first surfaces of both substrates at a predetermined angle between the substrates.

The partition wall member 21 is referred to as a black matrix (BM). To form the partition wall member 21, for example, a resinous material containing a black pigment or the like as a light-shielding material may be applied on the first surface of the opposing substrate 20 by printing such as offset printing to perform patterning. Furthermore, in a case of selecting a photosensitive material as the above resinous material, the resinous material can be patterned by photolithography after applied entirely on the first surface of the substrate 20. In the present embodiment, the color filter 22 (22G) is partitioned by the partition wall member 21, as well as a height of the partition wall member 21 is set such that the cell thicknesses d are maintained upon bonding of the pair of substrates together. Accordingly, in order to form the partition wall member 21 composed of a thick film, the material of the member may be applied a plurality of times for lamination. In this case, for example, the height of the partition wall member 21 is approximately 3.5 to 4 μm; a film thickness of the color filter 22 is approximately 1.5 to 2 μm; and the thickness of each of the first and the second liquid crystal layers 50a and 50b is approximately 2 μm. Additionally, preferably, a Y-direction length (namely, a width) of the partition wall member 21 separating the transmissive display region T from the reflective display region R is determined in consideration of a positional accuracy in the Y-axis direction upon bonding of the element substrate 10 with the opposing substrate 20 so as to allow the boundary between each of the transparent common electrodes 19t and each of the reflective common electrodes 19r to be positioned immediately under the partition wall member 21.

The color filter 22 is formed by filling a resinous material containing each color filter element forming material (a coloring material) in each of openings partitioned by the partition wall member 21. As a method for forming the color filter 22, a liquid droplet discharging method (an inkjet method) is used to apply each liquid that contains the above resinous material, and then the liquid applied is dried. Using the liquid droplet discharging method enables a necessary amount of the liquid to be more economically applied in the each sub pixel region partitioned by the partition wall member 21 than using photolithography. In addition, no photo mask is needed, thus enabling omission of production process steps such as exposure and development.

As shown in FIG. 3B, in the respective regions of the sub pixels partitioned by the partition wall member 21 are provided respective color filter elements 22R, 22G, and 22B included in the color filter 22.

The respective color filter elements 22R, 22G, and 22B have an approximately equal film thickness, thereby enabling color display. However, the film thicknesses of the filter elements may not necessarily be approximately equal. For example, among the respective colors or among same color filter elements, the film thickness may be made different between the reflective display region R and the transmissive display region T. This enables adjustment of color phase and chroma in a display color in accordance with optical characteristics of the reflective display region R and the transmissive display region T, thus improving the visual quality of color display.

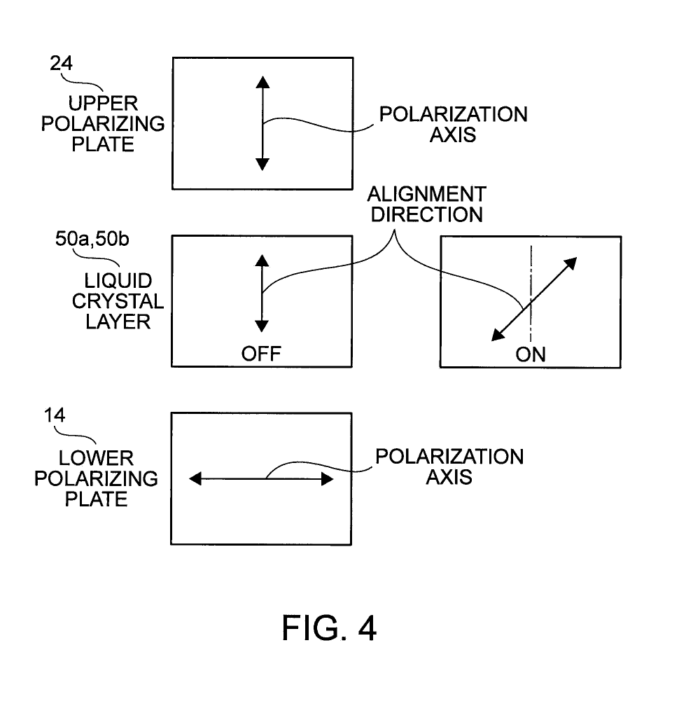

Next will be summarized optical design conditions regarding the liquid crystal device 100. FIG. 4 schematically shows an example of optical design conditions of the liquid crystal device 100. As shown in the drawing, under the optical design conditions of the liquid crystal device 100, a polarization axis of the upper polarizing plate 24 is orthogonal to a polarization axis of the lower polarizing plate 14. A direction of slow-axis alignment of liquid crystal molecules in the liquid crystal layer 50 (the first and the second liquid crystal layers 50a and 50b) is parallel to the polarization axis of the upper polarizing plate 24 in an off-state where no predetermined driving voltage is applied between the pixel electrode 9 and the common electrode 19. In contrast, in an on-state where a predetermined driving voltage is applied between the electrodes 9 and 19, the direction of the slow-axis alignment of the liquid crystal molecules intersects with the polarization axis of the upper polarizing plate 24 at an angle of 45 degrees. Thereby, in the off-state, transmitted light that is polarized after transmitting through the lower polarizing plate 14, namely, linearly polarized light is given a phase of λ/2 by the second liquid crystal layer 50b, whereby an oscillating direction of the transmitted light is shifted to a direction orthogonal to the polarization axis of the polarizing plate 24. That is, the oscillating direction of the transmitted light is turned parallel to an absorption axis of the plate, thereby shielding the light. Meanwhile, incident light polarized after transmitting through the upper polarizing plate 24 (linearly polarized light) in the reflective display region R is given a phase of λ/4 by the first liquid crystal layer 50a and thereby turned to be approximately circularly polarized light in an approximately whole visible wavelength range to be input to the reflective common electrode 19r. The light reflected by the reflective common electrode 19r is converted into polarized light perpendicular to the polarization axis of the upper polarizing plate 24 upon re-incidence to the upper polarizing plate 24. Accordingly, the light is not transmitted through the upper polarizing plate 24, resulting in a so-called black display state (a normally black state). In the on-state, the alignment direction of the liquid crystal molecules is at 45 degrees with respect to the polarization axes of the upper and the lower polarizing plates 24 and 14. Thus, the oscillating directions of transmitted light and reflected light transmitting through the color filter 22 become parallel to the polarization axis of the upper polarizing plate 24, thereby transmitting through the upper polarizing plate 24. As a result, there can be provided a color display state corresponding to the colors of the color filter elements 22R, 22G, and 22B.

As described hereinabove, the liquid crystal device 100 of the embodiment employs a so-called fringe field switching (FFS) mode. In the FFS mode, each of the sub pixels SG is partitioned into the reflective display region R and the transmissive display region T. Then, a driving voltage is applied between the pixel electrode 9 provided on and the common electrode 19 provided adjacent to the element substrate 10 to drive the liquid crystal layer 50 (the first and the second liquid crystal layers 50a and 50b). This suppresses coloring occurring in black display, thus realizing reflective and transmissive display technologies that reduce contrast loss.

In the liquid crystal display 100 thus structured, at a side adjacent to a rear surface (the second surface) of the element substrate 10 is provided an illumination device including a guiding plate that guides light from a light source such as a white light-emitting diode (LED) or a cold-cathode tube to the liquid crystal device 100, a diffusing plate, a reflecting plate, and the like.

Method for Producing the Liquid Crystal Device

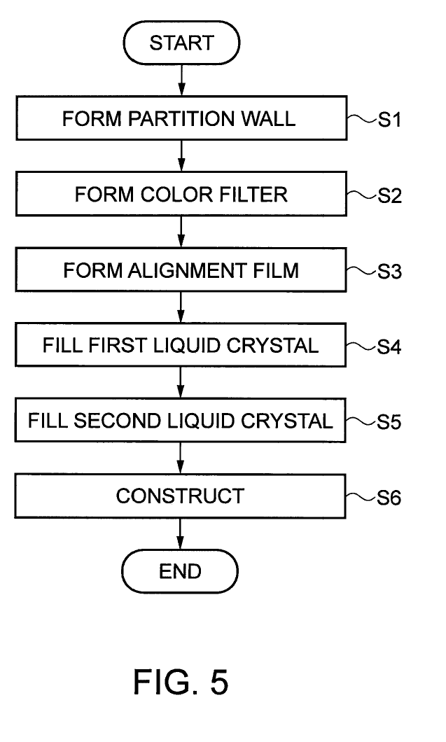

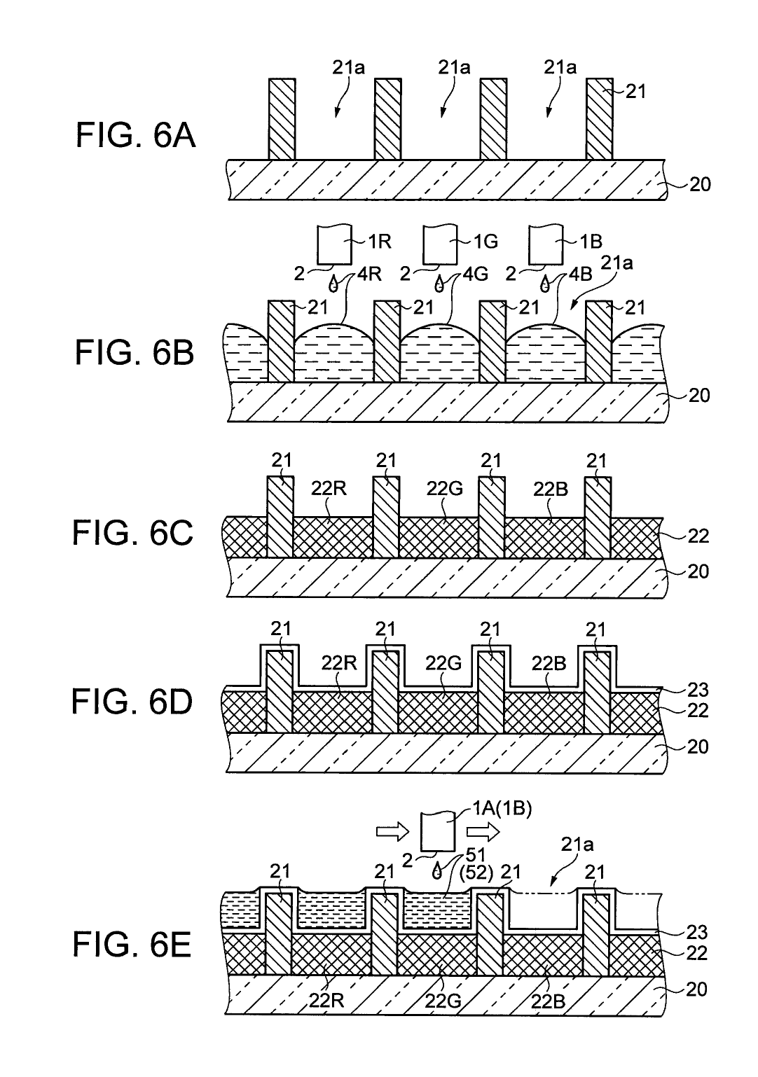

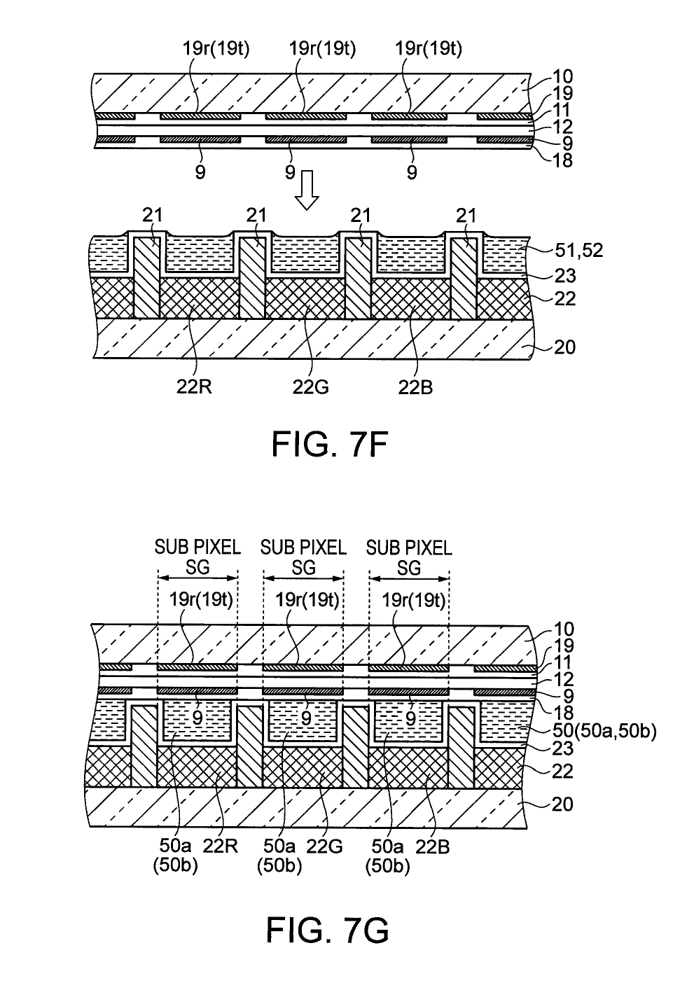

Next will be described a method for producing the liquid crystal device 100 of the embodiment with reference to drawings. FIG. 5 is a flowchart showing the producing method. FIGS. 6A to 6E and FIGS. 7F to 7G are schematic sectional views of the producing method.

As shown in FIG. 5, the method for producing the liquid crystal device 100 includes forming the partition wall member (step S1); forming the color filter (step S2); and forming the alignment film (step S3). Additionally, the method further includes filling the first liquid crystal (step S4); forming the second liquid crystal (step S5); and constructing by bonding together the element substrate 10 and the opposing substrate 20 as the pair of substrates so as to sandwich the liquid crystal layer 50 between the substrates (step S6).

Step S1 of FIG. 5 involves forming the partition wall member. At step S1, as shown in FIG. 6A, the partition wall member 21 is formed so as to have a plurality of openings 21a. Specifically, for example, on the first surface of the opposing substrate 20, a light-shielding material for the partition wall member is applied by printing such as offset printing to provide patterning, or a photosensitive material for the partition wall member is applied with a predetermined film thickness to be subjected to exposure and development, thereby forming a pattern of the partition wall member 21. The partition wall member 21 is formed such that sub pixel regions are partitioned so as to have openings therein, as well as the reflective display region R and the transmissive display region T are partitioned from each other (See FIGS. 3A and 3B). A film thickness of the partition wall member 21, namely the height of the member is adjusted such that the respective color filter elements 22R, 22G, and 22B, which will be formed later, are partitioned, as well as such that the height can maintain the layer thickness d (See FIGS. 3A and 3B) of each of the first and the second liquid crystal layers 50a and 50b. In the present embodiment, the height is from 3.5 to 4 μm. Then, next will be step S2.

Step S2 of FIG. 5 involves forming the color filter. At step S2, first, as shown in FIG. 6B, three different color liquids 4R, 4G, and 4B each containing a filter element forming material are applied in respective desired openings 21a (respective sub pixel regions partitioned by the partition wall member 21). In the present embodiment, the three different color liquids 4R, 4G, and 4B, respectively, are filled in different discharging heads 1R, 1G, and 1B, respectively. Then, relative scanning is performed between the discharging heads 1R, 1G, and 1B and the opposing substrate 20 to discharge droplets of the three different color liquids from a plurality of nozzles 2 provided in each of the discharging heads 1R, 1G, and 1B. In this case, the three different color liquids 4R, 4G, and 4B may be approximately simultaneously discharged or individually discharged. For example, using inkjet heads as the discharging heads 1R, 1G, and 1B enables necessary amounts of the liquids 4R, 4G, and 4B to be accurately and economically applied in the respective desired opening portions 21a.

Preferably, before applying the liquids 4R, 4G, and 4B, a lyophilic treatment is performed on an applying surface of the opposing substrate 20 having the partition wall member 21 formed thereon, whereas a lyophobic treatment is performed on the partition wall member 21. The lyophilic treatment may be a plasma treatment using oxygen gas as a process gas, and the lyophobic treatment may be a plasma treatment using CF₄ as a process gas. Performing such surface treatments enables the liquids 4R, 4G, and 4B to be evenly applied in the opening portions 21a.

Next, the applied liquids 4R, 4G, and 4B are dried to remove a solvent component, whereby, as shown in FIG. 6C, there can be obtained the respective filter elements 22R, 22G, and 22B corresponding to red (R), green (G), and blue (B), respectively, with respective predetermined film thicknesses (ranging approximately from 1.5 to 2 μm). Next will be step S3.

Step S3 of FIG. 5 involves forming the alignment film. At step S3, as shown in FIG. 6D, the alignment film 23 is formed to cover surfaces of the partition wall member and of the respective filter elements 22R, 22G, and 22B. To form the alignment film 23, for example, after applying an organic solution containing a polyimide or a polyamic oxide as an alignment film forming material, drying and burning are performed to remove a solvent component so as to deposit a film. In addition, the solution may be applied by spin coating, slit coating or the like, a printing process such as offset printing, or the liquid droplet discharging method. The alignment film 23 as a deposited film is subjected to a surface treatment such as rubbing in a predetermined direction. Furthermore, before applying the organic solution, surface treatment may be performed to improve wettability of the applying surfaces. Examples of the surface treatment include UV light irradiation and a plasma treatment using oxygen as a process gas. Next will be step S4.

Step S4 of FIG. 5 involves filling the first liquid crystal. The step is a first discharging process of discharging the first liquid crystal in each reflective display region R. At step S4 shown in FIG. 6E, a droplet of a first liquid crystal 51 is discharged in the reflective display region R partitioned by the partition wall member 21. To discharge the droplet, as in step S2, the first liquid crystal 51 is filled in a discharging head 1A having a plurality of nozzles 2 and then scanning operation is performed by relatively moving the discharging head 1A and the opposing substrate 20 to discharge the droplet of the first liquid crystal 51 from each of the nozzles 2. Thereby, a necessary amount of the first liquid crystal 51 can be accurately and economically applied in the each reflective display region R. Next will be step S5.

Step S5 of FIG. 5 involves filling the second liquid crystal. The step is a second discharging process of discharging the second liquid crystal in each transmissive display region T. At step S5 shown in FIG. 6E, as in step S4, a second liquid crystal 52 is filled in a discharging head 1B and a relative scanning operation between the discharging head 1B and the opposing substrate 20 is performed to discharge a droplet of the second liquid crystal 52 from each nozzle 2 in the transmissive display region T partitioned by the partition wall member 21. Thereby, a necessary amount of the second liquid crystal 52 can be accurately and economically applied in the each transmissive display region T. Then, the process proceeds to step S6.

At steps S4 and S5, depending on viscosities of materials selected for the first and the second liquid crystals, the materials are possibly not be suitable to the liquid droplet discharging method (the inkjet method). In that case, preferably, the liquid crystal materials or the discharging heads 1A and 1B are heated at a temperature equal to or higher than a room temperature to adjust such that the viscosity of each material is equal to or less than approximately 30 mPa·s. Additionally, to prevent the two kinds of the liquid crystal materials from being mixed with each other, preferably, amounts of the liquid crystal materials, respectively applied in the reflective display region R and the transmissive display region T, respectively, are reduced slightly less than the respective necessary amounts of the materials.

Furthermore, the two kinds of the liquid crystal materials may be applied in the same discharging process. In this case, the discharging heads 1A and 1B with the mutually different kinds of liquid crystal materials filled therein are relatively moved with respect to the opposing substrate 20 to perform scanning operation, whereby the two kinds of the liquid crystal materials can be approximately simultaneously discharged in respective desired regions.

In addition, as described above, the birefringence index of the first liquid crystal 51 is set to be less than that of the second liquid crystal 52, namely half the birefringence index of the second liquid crystal 52.

Step S6 of the FIG. 5 involves constructing. At step S6, first, as shown in FIG. 7F, the opposing substrate 20 having the first and the second liquid crystal materials 51 and 52 applied on the first surface thereof is arranged to oppose the element substrate 10 having the pixel electrodes 9 and the common electrodes 19 (the reflective and the transparent common electrodes 19r and 19t) at a predetermined position inside a chamber (not shown). Next, pressure inside the chamber is reduced to remove gasses such as nitrogen, oxygen, carbon dioxide, and vapor dissolved in the first and the second liquid crystals 51 and 52 applied. Following that, the element substrate 10 is bonded with the opposing substrate 20 via a sealant (an adhesive) provided so as to surround the display region including the pixels on one of the element substrate 10 and the opposing substrate 20. Such a sealant may be a UV or thermally curable epoxy or acryl adhesive. In this manner, as shown in FIG. 7G, between the element substrate 10 and the opposing substrate 20 are enclosed the first liquid crystal layer 50a made of the first liquid crystal 51 and the second liquid crystal layer 50b made of the second liquid crystal 52.

Onto respective top and bottom surfaces of a liquid crystal cell thus completed are attached the upper and the lower polarizing plates 24 and 14, respectively. Then, the liquid crystal cell is connected to the driving circuits to complete the liquid crystal device 100.

The method for producing the liquid crystal device 100 performed as above does not require process steps for optical compensation in the reflective and the transmissive display regions R and T, such as attachment of a phase difference plate to an outside surface of the liquid crystal cell and formation of a phase difference film inside the liquid crystal cell. As a result, the liquid crystal device 100 can be produced so as to realize reflective and transmissive displays in a more simplified structure.

In addition, as compared to a case of using the liquid crystal layer 50 made of a same single kind of liquid crystal material, the liquid crystal layer 50 of the present embodiment includes the first liquid crystal layer 50a made of the first liquid crystal 51 and the second liquid crystal layer 50b made of the second liquid crystal 52. This enables a liquid crystal material suitable to each of reflective display and transmissive display to be selected for use.

Furthermore, the color filter forming process (step S2) and the liquid crystal filling processes (steps S4 and S5) use the liquid droplet discharging method (the inkjet method), thereby eliminating loss of material use to enable the liquid crystal device 100 to be produced efficiently through the simplified production processes.

### Second Embodiment

Another Liquid Crystal Device

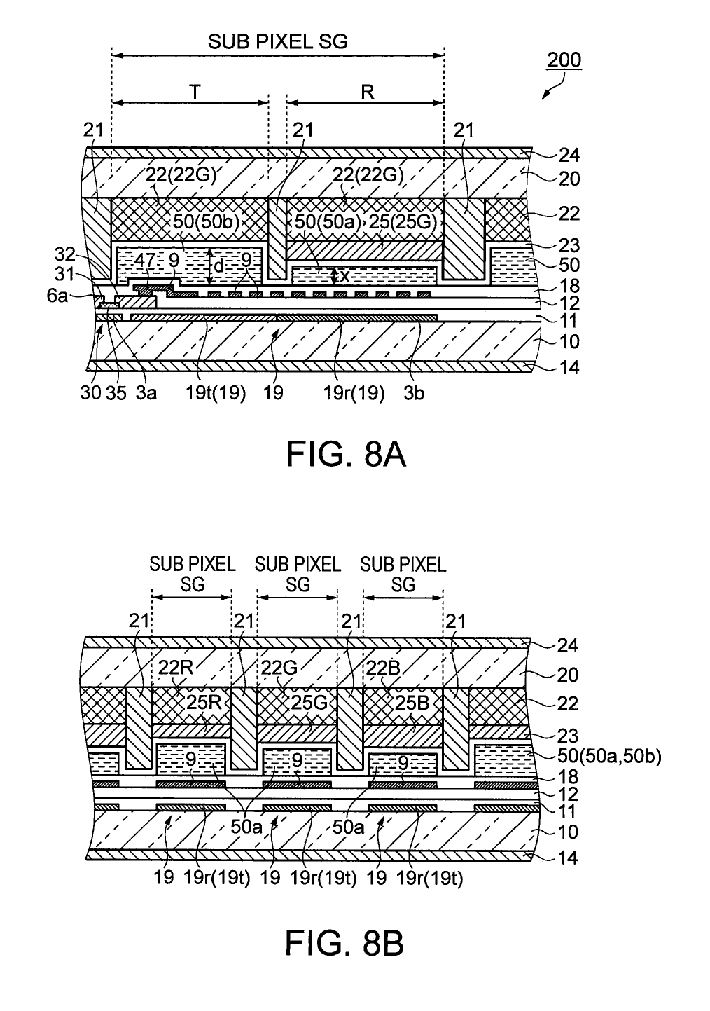

Next will be described a liquid crystal device according to a second embodiment of the invention and a method for producing the liquid crystal device, with reference to drawings. FIGS. 8A and 8B schematically show sectional views of a structure of the liquid crystal device according to the second embodiment. The same constituent elements as those in the first embodiment are given the same reference numerals in the description below.

As shown in FIG. 8A, unlike the first embodiment, a liquid crystal device 800 of the second embodiment further includes a liquid-crystal-layer-thickness adjusting layer 25 (25G) that adjusts a thickness of the first liquid crystal layer 50a in the reflective display region R. Basic optical design conditions of the liquid crystal device 200 are the same as those of the liquid crystal device 100 of the first embodiment, and thus the conditions shown in FIG. 4 can be employed.

The liquid-crystal-layer-thickness adjusting layer 25 (25G), which is transparent and optically isotropic, is laminated on the filter element 22G in the reflective display region R partitioned by the partition wall member 21. Thereby, the layer thickness of the first liquid crystal layer 50a in the reflective display region R is made different from that of the second liquid crystal layer 50b in the transmissive display region T. In the drawing, in the transmissive display region T, symbol d represents the layer thickness of the second liquid crystal layer 50b, whereas in the reflective display region R, symbol x, which is smaller (thinner) than d, represents the layer thickness of the first liquid crystal layer 50a.

As described above, the phase difference value of a liquid crystal layer is obtained by multiplying the birefringence index Δn of liquid crystal of the liquid crystal layer by a layer thickness. Thus, a phase difference value of the first liquid crystal layer 50a is represented by an expression: Δn₁×x, and a phase difference value of the second liquid crystal layer 50b is represented by an expression: Δn₂×d. When a phase difference value of reflected light in the reflective display region is approximately equal to that of transmitted light in the transmissive display region T, namely, when an equation: 2Δn₁×x=Δn₂×d is established, a value of x is equal to (Δn₂/2Δn₁)d. Allowing the thickness x of the first liquid crystal layer 50a to be smaller than the thickness d of the second liquid crystal layer 50b enables the birefringence index Δn₁ of the first liquid crystal 51 of the first liquid crystal layer 50a to be close to the birefringence index Δn₂ of the second liquid crystal 52 of the second liquid crystal layer 50b.

Therefore, the first and the second liquid crystals 51 and 52 can be selected from a group of liquid crystal materials similar in optical characteristics such as temperature dependence. This can provide a wider range of options for the liquid crystal materials, as well as can facilitate adjustment of the optical characteristics in the reflective and the transmissive display regions R and T.

In addition, as shown in FIG. 8B, a thickness of the liquid-crystal-layer-thickness adjusting layer 25 may be made different depending on the colors of the respective color filter elements 22R, 22G, and 22B. This enables optical color correction in reflective display in accordance with absorption wavelengths of the respective color filter elements 22R, 22G, and 22B. In this case, based on a thickness of the liquid-crystal-layer-thickness adjusting layer 25G corresponding to the green (G) filter element 22G, a thickness of the liquid-crystal-layer-thickness adjusting layer 25R corresponding to the red (R) filter element 22R is made smaller, whereas a thickness of the liquid-crystal-layer-thickness adjusting layer 25B corresponding to the blue (B) filter element 22B is made larger.

Alternatively, the thicknesses of the liquid-crystal-layer-thickness adjusting layers 25R, 25G, and 25B may not be different from one another. For example, a thickness of the liquid-crystal-layer-thickness adjusting layer 25 corresponding to at least one of the color filter elements may be different from a thickness of the liquid-crystal-layer-thickness adjusting layer 25 corresponding to at least another one of the color filter elements, thereby obtaining appropriate advantageous effects.

Method for Producing the Other Liquid Crystal Device

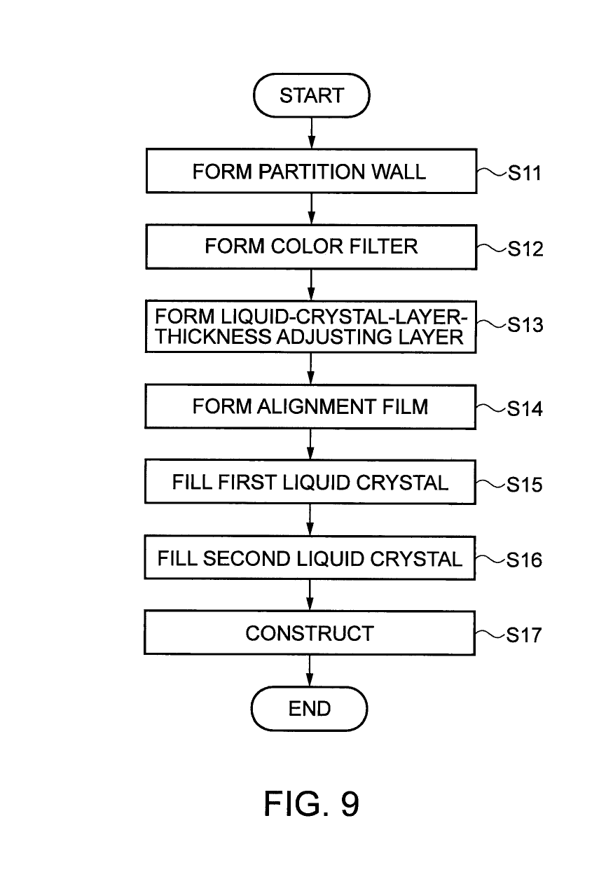

Next will be described a method for producing the liquid crystal device of the second embodiment, with reference to drawings. FIG. 9 is a flowchart showing the producing method.

As shown in FIG. 9, the method for producing the liquid crystal device 200 of the second embodiment includes forming the partition wall member (step S11); forming the color filter (step S12); forming the liquid-crystal-layer-thickness adjusting layer (step S13); and forming the alignment film (step S14). Additionally, the method includes filling the first liquid crystal (step S15); filling the second liquid crystal (step S16); and constructing by bonding together the element substrate 10 and the opposing substrate 20 as the pair of substrates so as to sandwich the liquid crystal layer 50 between the substrates (step S17). Description will be omitted regarding the same production process steps as those in the method for producing the liquid crystal device 100 of the first embodiment.

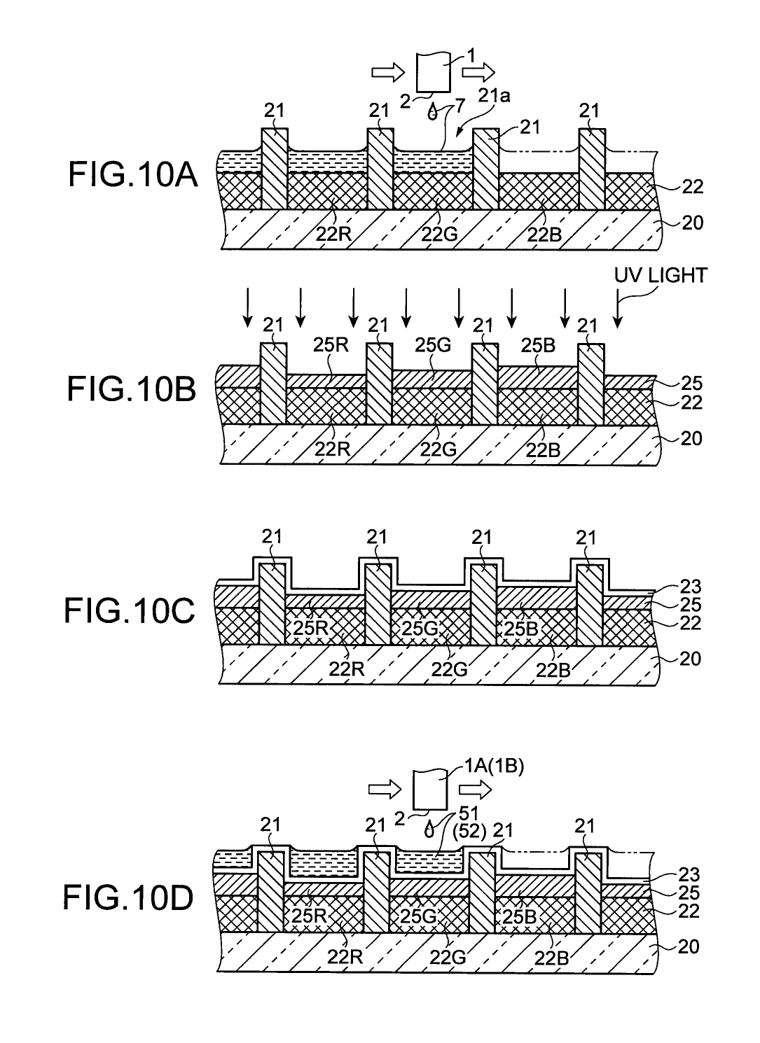

FIGS. 10A to 10D are schematic sectional views showing the method for producing the liquid crystal device 200 of the second embodiment.

Step 11 of FIG. 9 involves forming the partition wall member. At step 11, as in step S1 of the first embodiment, the partition wall member 12 is formed so as to partition the sub pixel regions to have openings therein, as well as so as to partition the reflective and the transmissive display regions R and T.

Step S12 of FIG. 9 involves forming the color filter. At step S12, as in step S2 of the first embodiment, the three different color liquids 4R, 4G, and 4B each containing a filter element forming material are applied in respective desired openings 21a (the sub pixel regions) and then dried to form the three different color filter elements 22R, 22G, and 22B (See FIGS. 6B and 6C). Next will be step S13.

Step S13 of FIG. 9 involves forming the liquid-crystal-layer-thickness adjusting layer. At step S13, as shown in FIG. 10A, first, a liquid 7 containing a material of the liquid-crystal-layer-thickness adjusting layer is applied in the reflective display region R partitioned by the partition wall member 21. Also in this case, the liquid droplet discharging method (the inkjet method) is used to fill the liquid 7 in the discharging head 1. Then, a relative scanning operation between the discharging head 1 and the opposing substrate 20 is performed to discharge a droplet of the liquid 7 from each of the nozzles 2 of the discharging head 1.

For example, the liquid-crystal-layer-thickness adjusting layer may be made of a photo-curable acryl resin. In addition, an amount of the liquid 7 applied in the corresponding opening portion 21a is varied such that a film thickness of the liquid 7 is different after deposited on each of the three different color filter elements 22R, 22G, and 22B.

Next, as shown in FIG. 10B, the applied liquid 7 is cured by irradiating UV light to form the respective liquid-crystal-layer-thickness adjusting layers 25R, 25G, and 25B. The thicknesses of the adjusting layers 25R and 25B are determined based on the thickness of the adjusting layer 25G. The material for forming the liquid-crystal-layer thickness adjusting layers is not restricted to the photo-curable acryl resin. The adjusting layers may be made of a thermally curable resin as long as the resinous material can secure transparency and isotropy. Next will be step S14.

Step S14 of FIG. 9 involves forming the alignment film. At step S14 shown in FIG. 10C, as in step S3 of the first embodiment, the alignment film 23 is formed so as to cover the partition wall member 21 and the liquid-crystal-layer-thickness adjusting layers 25R, 25G, and 25B. After deposition of the alignment film 23, the alignment film 23 is subjected to surface treatment such as rubbing in a predetermined direction. Then, next will be step S15.

Step S15 of FIG. 9 involves filling the first liquid crystal. At step S15 shown in FIG. 10D, as in step S4 of the first embodiment, the first liquid crystal 51 is filled in the discharging head 1A to discharge a droplet of the first liquid crystal 51 from each of the nozzles 2 in the reflective display region R partitioned by the partition wall member 21. Next will be step S16.

Step S16 of FIG. 9 involves filling the second liquid crystal. At step S16 shown in FIG. 10D, as in step S5 of the first embodiment, the second liquid crystal 52 is filled in the discharging head 1B to discharge a droplet of the second liquid crystal 52 from each of the nozzles 2 in the transmissive display region T partitioned by the partition wall member 21.

At steps S15 and S16 described above, the respective amounts of the liquid crystal materials applied are varied in each of the color filter elements 22R, 22G, and 22B.

Step S17 of FIG. 9 involves constructing. At step S17, as in step S6 of the first embodiment, the opposing substrate 20 with the first and the second liquid crystals 51 and 52 applied thereon is bonded with the element substrate 10 to be constructed so as to complete the liquid crystal cell. Then, onto the top and the bottom surfaces of the liquid crystal cell completed, respectively, are attached the upper and the lower polarizing plates 24 and 14, respectively. Thereby, the liquid crystal device 200 shown in FIGS. 8A and 8B is constructed.

In the above method for producing the liquid crystal device 200, in addition to advantageous effects of the first embodiment, including additionally the liquid-crystal layer thickness adjusting layers 25 (25R, 25G, and 25B) can provide a wider range of material options for the first and the second liquid crystals 51 and 52. Furthermore, allowing the thicknesses of the respective liquid-crystal layer thickness adjusting layers 25R, 25G, and 25B to be different from one another enables color correction of display color in reflective display.

### Third Embodiment

Electronic Apparatus

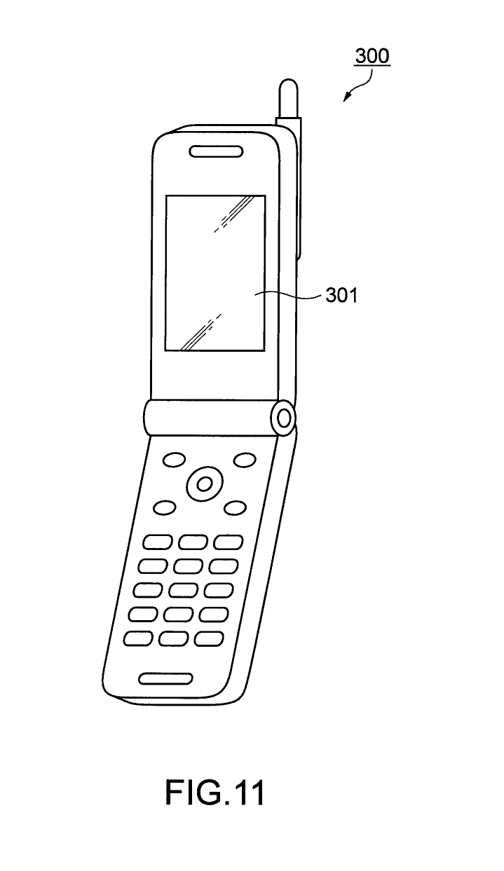

Next will be described a mobile phone as an example of an electronic apparatus according to a third embodiment of the invention. FIG. 11 is a schematic perspective view showing the mobile phone as the electronic apparatus.

As shown in FIG. 11, a mobile phone 300 of the third embodiment has a main body including an operating input section and a display section 301. The display section 301 incorporates the liquid crystal device 100 or 200 and an illumination device that illuminates the liquid crystal device. Accordingly, displayed information can be recognized by transmissive display using transmitted light from the illumination device and reflective display using incident light such as external light. That is, under a sufficiently bright condition such as an outdoor environment, reflective display enables information to be recognized without driving the illumination device. Thus, the mobile phone 300 realizes power consumption reduction and offers a long battery life.

The mobile phone 300 includes the liquid crystal 100 of the first embodiment, the liquid crystal device 200 of the second embodiment, the liquid crystal device 100 produced by the method for producing the liquid crystal device 100, or the liquid crystal device 200 produced by the method for producing the liquid crystal device 200. Accordingly, the mobile phone 300 provides a high-visual display quality and an excellent cost performance ratio.

Other than the above embodiments, various modifications may be considered. Some modifications will be described below.

### First Modification

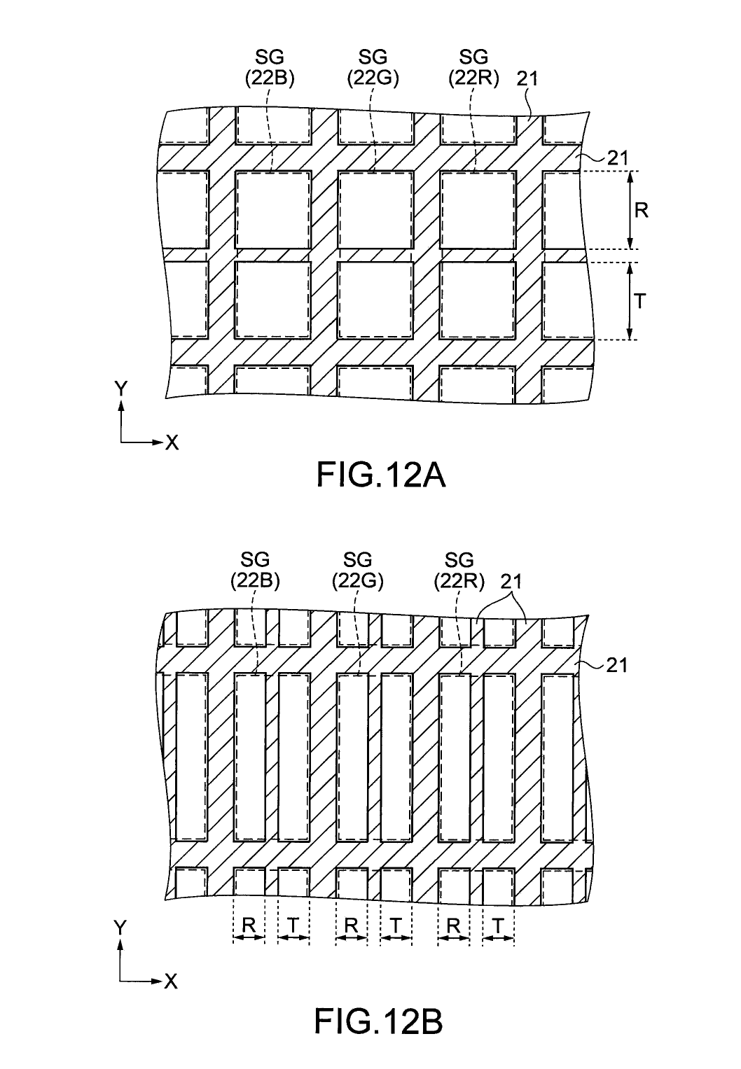

In the liquid crystal device 100 of the first embodiment, the layout of the partition wall member 21 is not restricted to the layout thereof shown in the embodiment. FIGS. 12A and 12B are schematic plan views showing other layout patterns of the partition wall member 21. Like the first embodiment, in FIG. 12A, the partition wall member 21 is provided in a lattice shape to partition the respective sub pixels SG (substantially, the respective filter elements 22R, 22G, and 22B), as well as to partition the reflective display region R from the transmissive display region T in the Y-axis direction (a direction in which the same-color filter elements are arranged in a striped shape). In contrast, as shown in FIG. 12B, the reflective display region R and the transmissive display region T may be partitioned from each other in an X-axis direction orthogonal to the Y-axis direction. Thus, when separating the reflective and the transmissive display regions R and T by the partition wall member 21, more effective layouts of the display regions R and T may be determined in consideration of a shape, visual angle characteristics and the like of the sub pixels SG. Other than this, inside each of the sub pixels SG, the reflective display region R may be provided independently in an island shape.

### Second Modification

In the liquid crystal device 200 of the second embodiment, layouts of the partition wall member 21 and the liquid-crystal-layer-thickness adjusting layers 25 are not restricted to those described above. For example, in FIGS. 8A and 8B, the color filter 22 may be provided on the opposing substrate 20, whereas the partition wall member 21 and the liquid-crystal-layer-thickness adjusting layers 25 partitioned by the partition wall member 21 may be arranged at a side adjacent to the element substrate 10. This structure can also provide similar advantageous effects. Furthermore, thereby, the side adjacent to the opposing substrate 20 is structurally simplified, so that the opposing substrate 20 as a raw material substrate including the color filter 22 is available from external manufacturers.

### Third Modification

In the liquid crystal device 100 of the first embodiment, the structure of the sub pixel SG realizing the reflective display region R is not restricted to providing the reflective common electrode 19r having light reflectivity. For example, the transparent common electrode 19t may be provided in the same size as that of the pixel electrode 9 in a two-dimensional view, and a reflecting layer having light reflectivity may be provided as an underlayer of the transparent common electrode 19t. The reflecting layer may be formed by depositing a thin film made of a metal such as Al or Ag on a resin layer having a plurality of concave and convex portions. The reflecting layer as above is formed to correspond to the reflective display region R. This can reduce directivity of light reflected by the reflecting layer, thereby realizing brighter reflective display.

### Fourth Modification

In the liquid crystal device 100 of the first embodiment, layouts of the three different color filter elements 22R, 22G, and 22B are not restricted to a stripe mode as above. For example, the structure of the liquid crystal layer 50 of the first embodiment may also be applied to a layout of a mosaic or delta mode. In addition, colors included in the color filter 22 are not restricted to the above three colors. The color filter 22 may be of a multicolor type including at least one color in addition to red, green, and blue. Furthermore, the liquid crystal device 100 may be applicable to a semi-transmissive reflective liquid crystal panel allowing only a so-called monochrome display, without including the color filter 22.

### Fifth Modification

The liquid crystal device 100 of the first embodiment and the liquid crystal device 200 of the second embodiment are not restricted to the semi-transmissive reflective liquid crystal device of the FFS mode. For example, the liquid crystal devices 100 and 200 may also be applicable to a semi-transmissive reflective liquid crystal panel of the IPS mode or a vertical alignment (VA) mode. In addition, instead of the TFT 30, a thin film diode (TFD) element may be used as a switching element. Furthermore, the liquid crystal devices 100 and 200 are not restricted to the active-mode liquid crystal device including the switching element and may also be applicable to a liquid crystal device of a simple matrix mode.

### Sixth Embodiment

In the method for producing the liquid crystal device 100 of the first embodiment, the method for forming the color filter 22 is not restricted to the liquid droplet discharging method. For example, after forming the color filter 22 by photolithography, the partition wall member 21 may be formed on the color filter 22.

### Seventh Modification

In the method for producing the liquid crystal device 200 of the second embodiment, the film thicknesses of the liquid-crystal-layer-thickness adjusting layers 25 are varied among the respective display colors. However, instead of that, for example, the film thicknesses of the thickness adjusting layers 25 may be equalized regardless of the display color. This can omit the step of adjusting the film thicknesses thereof, thus further simplifying the production process of the liquid crystal device 200.

### Eighth Modification

In the third embodiment, the electronic apparatus incorporating the liquid crystal device 100 or 200 is not restricted to the mobile phone 300. The liquid crystal devices 100 and 200 can also be suitably incorporated in other various kinds of electronic apparatuses such as notebook personal computers, electronic organizers, viewers and DVD players displaying visual data, and mobile data terminals, for example.

The entire disclosure of Japanese Patent Application No. 2007-308411, filed Nov. 29, 2007 is expressly incorporated by reference herein.

What is claimed is:

1. A liquid crystal device, comprising:
a pair of substrates;
a partition wall member that partitions a region sandwiched between the pair of substrates to provide reflective display regions and transmissive display regions;
a plurality of pixels each including a plurality of pixel regions, each of the pixel regions having each of the reflective display regions and each of the transmissive display regions; and
a first liquid crystal layer made of a first liquid crystal and a second crystal layer made of a second liquid crystal, the first and the second liquid crystal layers, respectively, being enclosed in the reflective display region and the transmissive display region, respectively, partitioned by the partition wall member so as to sandwich the first and the second liquid crystal layers between the pair of substrates, wherein a phase difference value of reflected light in the first liquid crystal layer is approximately equal to a phase difference value of transmitted light in the second liquid crystal layer.

2. The liquid crystal device according to claim 1, wherein a layer thickness of the first liquid crystal layer is approximately equal to a layer thickness of the second liquid crystal layer, and a birefringence index of the first liquid crystal is half a birefringence index of the second liquid crystal.

3. The liquid crystal device according to claim 1, wherein one substrate of the pair of substrates includes a liquid-crystal-layer-thickness adjusting layer in the reflective display region to adjust a thickness of the first liquid crystal layer such that the thickness of the first liquid crystal layer is smaller than a thickness of the second liquid crystal layer, and a birefringence index of the first liquid crystal is smaller than a birefringence index of the second liquid crystal.

4. The liquid crystal device according to claim 1, wherein one substrate of the pair of substrates includes a color filter having a plurality of different color filter elements, each of the color filter elements being provided in each of the pixel regions partitioned by the partition wall member.

5. The liquid crystal device according to claim 1, wherein one substrate of the pair of substrates includes a color filter having a plurality of different color filter elements, each of the color filter elements being provided in each of the pixel regions partitioned by the partition wall member, and a liquid-crystal-layer-thickness adjusting layer provided in the reflective display region to adjust a thickness of the first liquid crystal layer, a thickness of the liquid-crystal-layer-thickness adjusting layer corresponding to at least one of the color filter elements is different from a thickness of the liquid-crystal-layer-thickness adjusting layer corresponding to at least another one of the color filter elements.

6. The liquid crystal device according to claim 1, wherein the partition wall member is made of a light-shielding material.

7. A method for producing a liquid crystal device, comprising:
forming a partition wall member on one substrate of a pair of substrates to partition a plurality of pixels each including a plurality of pixel regions, each of the pixel regions having a reflective display region and a transmissive region, as well as to partition the reflective display region from the transmissive display region;
filling a first liquid crystal and a second liquid crystal, respectively, in the reflective display region and the transmissive display region, respectively, partitioned from each other by the partition wall member on the one substrate; and
bonding the pair of substrates together so as to sandwich a first liquid crystal layer made of the first liquid crystal and a second liquid crystal layer made of the second liquid crystal between the substrates, wherein the first and the second liquid crystals are selected such that a phase difference value of reflected light in the first liquid crystal layer is approximately equal to a phase difference value of transmitted light in the second liquid crystal layer.

8. The method for producing a liquid crystal device according to claim 7, wherein the partition wall member is formed using a light-shielding material.

9. The method for producing a liquid crystal device according to claim 7, wherein in the constructing, the pair of substrates are bonded together such that a layer thickness of the first liquid crystal layer is approximately equal to a thickness of the second liquid crystal layer, and a birefringence index of the first liquid crystal is half a birefringence index of the second liquid crystal.

10. The method for producing a liquid crystal device according to claim 7, further including forming a liquid-crystal-layer-thickness adjusting layer in the reflective display region partitioned by the partition wall member on the one substrate to adjust a thickness of the first liquid crystal layer; and wherein, in the constructing, the first liquid crystal filled in the reflective display region has a birefringence index smaller than a birefringence index of the second liquid crystal.

11. The method for producing a liquid crystal device according to claim 7, further including forming a color filter having a plurality of different color filter elements such that each of the different color filter elements is formed in each of the pixel regions partitioned by the partition wall member on the one substrate.

12. The method for producing a liquid crystal device according to claim 7, further including forming a color filter having a plurality of color filter elements such that each of the color filter elements is formed in each of the pixel regions partitioned by the partition wall member on the one substrate, and forming a liquid-crystal-layer-thickness adjusting layer in the reflective display region partitioned by the partition wall member on the one substrate to adjust a thickness of the first liquid crystal layer, wherein the liquid-crystal-layer-thickness adjusting layer is formed such that a thickness of the liquid-crystal-layer-thickness adjusting layer corresponding to at least one of the different color filter elements is different from a thickness of the liquid-crystal-layer-thickness adjusting layer corresponding to at least another one of the different color filter elements.

13. The method for producing a liquid crystal device according to claim 10, wherein forming the liquid-crystal-layer-thickness adjusting layer includes applying a droplet of a liquid containing a material of the liquid-crystal-layer-thickness adjusting layer in the reflective display region, and then forming a deposit film by drying the applied liquid to obtain the liquid-crystal-layer-thickness adjusting layer.

14. The method for producing a liquid crystal device according to claim 11, wherein forming the color filter includes applying a droplet of each of at least three different color liquids in each of the pixel regions, the droplet of the each of the liquids containing a material of each of the different color filter elements, and then forming deposit films by solidifying the applied droplets to obtain the color filter elements having at least three colors of red, green, and blue.

15. The method for producing a liquid crystal device according to claim 7, wherein the constructing includes first discharging a droplet of the first liquid crystal in the reflective display region, and then discharging a droplet of the second liquid crystal in the transmissive display region.

16. An electronic apparatus including the liquid crystal device according to claim 1 or a liquid crystal device produced by the method according to claim 7.
